(19) United States
(12) Patent Application Publication
(10) Pub. No.: US 2010/0060760 A1
(43) Pub. Date: Mar. 11, 2010

(54) IMAGING APPARATUS AND DUST REDUCTION APPARATUS

(75) Inventor: Mikio Sakurai, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/556,631

(22) Filed: Sep. 10, 2009

(30) Foreign Application Priority Data
Sep. 11, 2008 (JP) 2008-233200

(51) Int. Cl. H04N 5/335; F28G 7/00

(52) U.S. Cl. 348/294; 15/94

(57) ABSTRACT

An imaging apparatus includes an imaging device operable to convert light to an electrical signal, a vibrating unit including an optical member arranged on a light-receiving surface side of the imaging device, a vibration applying unit arranged to contact the vibrating unit and vibrates upon application of a voltage, the vibration applying unit vibrating integrally with the vibrating unit to vibrate the vibrating unit, and a member operable to sandwich the vibrating unit and the vibration applying unit. A zero-amplitude reference plane of resonance produced by the integral vibration of the vibrating unit and the vibration applying unit is located on the vibrating unit.

### BACKGROUND

1. Technical Field

The technical field relates to an imaging apparatus having an imaging device and more particularly to an imaging apparatus having an anti-dust function of an imaging device.

2. Related Art

In a conventional digital camera, particularly, a lens-interchangeable digital camera, upon change of a lens or the like, foreign particles, dust and the like, may enter a camera body and adhere to an imaging device in the camera body. The foreign particles, dust and the like, adhering to the imaging device may cause degradation in quality of an image obtained with the imaging device. To solve a problem of such degradation in image quality due to the adherence of foreign particles, dust and the like, to the imaging device, various cameras are proposed that have an anti-dust function in which an anti-dust filter for preventing dust from adhering to an imaging device is arranged at the front of the imaging device and is vibrated to shale off dust adhering to the imaging device (see JP-A-2003-348401).

To more effectively perform the anti-dust function in a camera having the above-described configuration, it is important to more efficiently vibrate the anti-dust filter.

To solve the above problem, an imaging apparatus is provided that improves the vibration capability to a piezoelectric element by an anti-dust filter.

### SUMMARY

In a first aspect, there is provided an imaging apparatus. The imaging apparatus includes: an imaging device operable to convert light to an electrical signal; a vibrating unit including an optical member arranged on a light-receiving surface side of the imaging device; a vibration applying unit arranged to contact the vibrating unit and vibrates upon application of a voltage, the vibration applying unit vibrating integrally with the vibrating unit to vibrate the vibrating unit; and a member operable to sandwich the vibrating unit and the vibration applying unit. A zero-amplitude reference plane of resonance produced by the integral vibration of the vibrating unit and the vibration applying unit is located on the vibrating unit. For example, the thickness of the vibrating unit is made greater than the thickness of the vibration applying unit.

In a second aspect, there is provided a dust reduction apparatus for preventing adherence of dust onto a predetermined member. The dust reduction apparatus includes: a vibrating unit that can be arranged at a front of the predetermined member; a vibration applying unit arranged to contact the vibrating unit and vibrates upon application of a voltage, the vibration applying unit vibrating integrally with the vibrating unit to vibrate the vibrating unit; and a member operable to sandwich the vibrating unit and the vibration applying unit. A zero-amplitude reference plane of resonance produced by the integral vibration of the vibrating unit and the vibration applying unit is located on the vibrating unit. For example, the thickness of the vibrating unit is made greater than the thickness of the vibration applying unit.

With the above configuration, a zero-amplitude reference plane of resonance occurring due to vibration of the vibrating unit and the vibration applying unit which vibrate integrally is located on the vibrating unit, so that the vibration applying unit is not inhibited from vibrating and thus the vibration capability of the vibrating unit (for example, an anti-dust filter) is improved.

### BRIEF DESCRIPTION OF DRAWINGS

FIG. 1 is a block diagram showing a configuration of a camera having mirrors according to an embodiment.

FIG. 2 is a block diagram showing a configuration of a camera having no mirror according to another embodiment.

FIG. 3 is an exploded perspective view of an anti-dust unit according to an embodiment.

FIG. 4 is a cross-sectional view of the anti-dust unit according to the embodiment.

FIG. 5 is a block diagram of a drive circuit of the anti-dust unit according to the embodiment.

FIGS. 6A to 6C are diagrams describing resonance of an anti-dust filter.

FIG. 7 is a diagram describing a relationship between the thickness ratio between the anti-dust filter and a piezoelectric element and drive capability, according to the embodiment.

FIGS. 8A to 8C are diagrams describing a relationship between a zero-amplitude reference plane of resonance occurring upon vibration of the anti-dust filter and the piezoelectric element and the ratio between the thickness of the anti-dust filter and the thickness of the piezoelectric element.

### DETAIL DESCRIPTION OF PREFERRED EMBODIMENT

An embodiment of an imaging apparatus and a dust reduction apparatus will be described in detail below with reference to the accompanied drawings.

### 1. Configuration

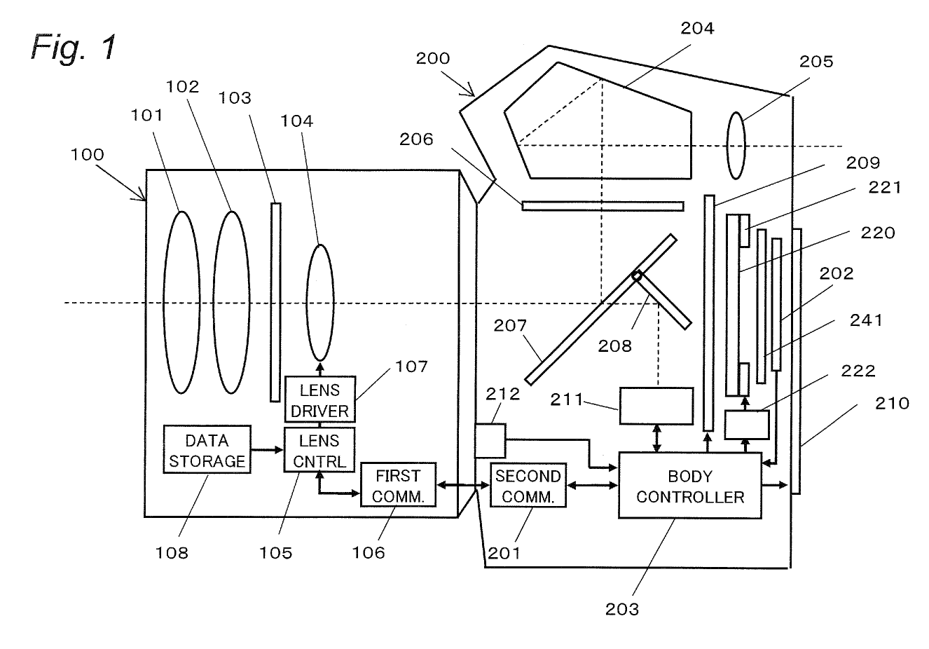

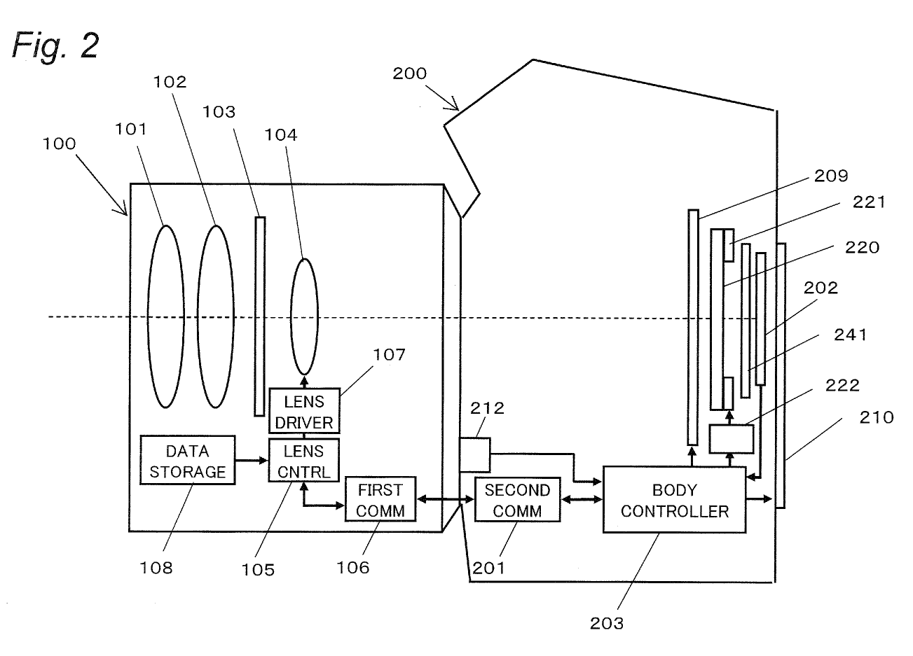

FIGS. 1 and 2 are block diagrams showing configurations of imaging apparatuses according to embodiments. The imaging apparatuses include an interchangeable lens 100 and a camera body 200. The interchangeable lens 100 is mountable to the camera body 200 at a predetermined position of the camera body 200.

FIG. 1 is a block diagram showing a configuration of a camera having mirrors and FIG. 2 is a block diagram showing a configuration of a camera having no mirror.

### 1-1. Camera

The configuration of a camera having mirrors will be described in detail with reference to FIG. 1.

A main mirror 207 reflects a part of subject light incident through the interchangeable lens 100 and transmits a part of the subject light. The subject light reflected on the main mirror 207 forms an image on a reticle 206. The main mirror 207 is a half-silvered mirror and a submirror 208 is a normal mirror. A person who shoots a photograph can visually recognize the subject image formed on the reticle 206 through an eyepiece lens 205 and a pentaprism 204.

The subject light transmitted through the main mirror 207 is reflected by the submirror 208 and enters a focus detection unit 211. The focus detection unit 211 is composed of a line sensor. A body controller 203 can recognize a focus state from an output from the focus detection unit 211. A method for focusing automatically using an output from the focus detection unit 211 is generally called a phase difference detection method.

A shutter 209 and an imaging device 202 are provided at the rear, on an optical axis, of the submirror 208. When the submirror 208 is arranged on the optical axis, subject light does not reach the imaging device 202 and thus the shutter 209 is closed. On the other hand, when the submirror 208 retreats from the optical axis, a beam of light passing through the interchangeable lens 100 forms an image on an imaging plane of the imaging device 202. The imaging device 202 is composed of a CCD image sensor or a CMOS image sensor.

An anti-dust filter 220 is arranged between the shutter 209 and the imaging device 202. That is, the anti-dust filter 220 is arranged on the light-receiving surface side of the imaging device 202. The anti-dust filter 220 may be a transparent plate or may be an optical LPF (low-pass filter). When the anti-dust filter 220 is a transparent plate, an optical LPF 241 is additionally arranged between the anti-dust filter 220 (transparent plate) and the imaging device 202. On the other hand, when the anti-dust filter 220 is an optical LPF, only part of a plurality of optical members composing an optical LPF may be used as the anti-dust filter 220. A piezoelectric element 221 is fixed to an outer edge of the anti-dust filter 220 by an adhesive or the like. The piezoelectric element 221 is connected to a drive circuit 222 and is driven by application of a voltage of a predetermined (fixed or variable) frequency from the drive circuit 222. The anti-dust filter 220 vibrates with the drive of the piezoelectric element 221. Foreign particles, dust and the like, having entered the camera body 200 upon change of the lens or the like, may move around the camera body 200 when the mirror 207 and the submirror 208 move, and adhere to the anti-dust filter 220. The foreign particles, dust and the like, having adhered to a surface of the anti-dust filter 220 can be removed by vibrating the anti-dust filter 220.

An image signal outputted from the imaging device 202 is converted to image data by the body controller 203 and then the image data is displayed on an image display unit 210. The image display unit 210 is composed of a liquid crystal display device or an organic EL display. The person who shoots a photograph can visually recognize a subject image with the image display unit 210. An operation mode in such a state is called a “live view mode”. The body controller 203 can recognize a focus state from a contrast of image data based on an image signal outputted from the imaging device 202. A focusing method for focusing automatically using an output from the imaging device 202 is generally called a “mountain-climbing scheme”.

An attachment detection unit 212 can detect attachment of the interchangeable lens 100 to the camera body 200. The attachment detection unit 212 can be achieved by a mechanical switch or the like. The body controller 203 can recognize attachment of the interchangeable lens 100 by monitoring a state of the attachment detection unit 212. Note that the attachment detection unit 212 is not an essential element in the present embodiment. The body controller 203 may detect attachment of the interchangeable lens 100 to the camera body 200 by communicating with a lens controller 105 through a second communicating unit 201 and a first communicating unit 106.

The body controller 203 has, in addition to the above-described functions, a function of converting an image signal outputted from the imaging device 202 to image data and recording the image data in a recording medium (not shown). The body controller 203 may be a single LSI or may be composed of a plurality of LSIs. The second communicating unit 201 may be a dedicated LSI or the body controller 203 may include the function of the second communicating unit 201. Although the camera body 200 is equipped with a release button used by the person who shoots a photograph to provide an instruction for shooting, a mode dial used to switch between various modes of the camera body 200, a battery and a power circuit that supply power to the components of the camera body 200 and the interchangeable lens 100 or the like, they are not shown in FIGS. 1 and 2.

Comparing with the configuration of a camera having mirrors shown in FIG. 1, the configuration of a camera having no mirror shown in FIG. 2 does not include a pentaprism 204, an eyepiece lens 205, a reticle 206, a main mirror 207, a submirror 208, and a focus detection unit 211. The other components are the same as those in FIG. 1 and thus description thereof is not repeated Note, however, that in this case an EVF (electronic viewfinder) may be added.

Foreign particles, dust and the like, having entered a camera body 200 upon change of a lens or the like, may adhere to an anti-dust filter 220. A piezoelectric element 221 is driven by application of a voltage of a predetermined (fixed or variable) frequency from a drive circuit 222. The anti-dust filter 220 vibrates with the drive of the piezoelectric element 221 so that the foreign particles, dust and the like, adhering to a surface can be removed by this vibration.

### 1-2. Configuration of an Anti-Dust Unit

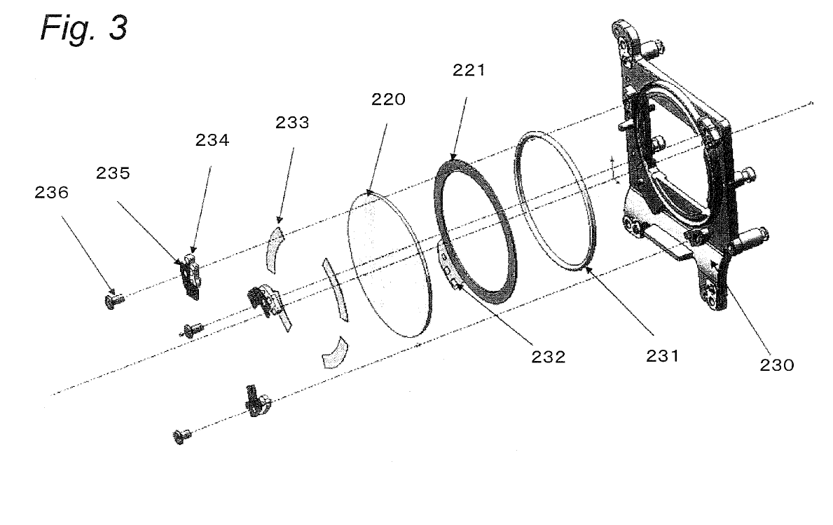

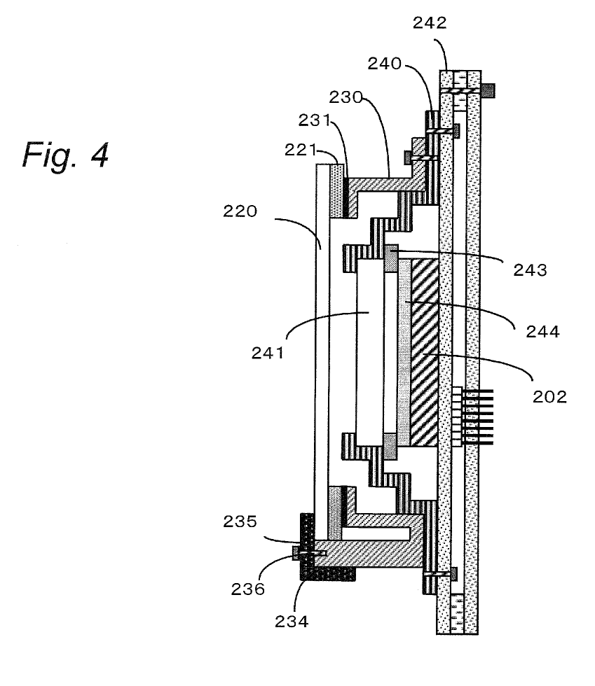

The anti-dust filter 220 and the piezoelectric element 221 in FIGS. 1 and 2 are part of the configuration of an anti-dust unit. The anti-dust unit will be described in detail below with reference to FIGS. 3 and 4. FIG. 3 is an exploded perspective view of the anti-dust unit and FIG. 4 is a cross-sectional view of the anti-dust unit including the associated members related to the imaging device 202.

An anti-dust filter receiving member 230 is fixed at the front of the imaging device 202 by screw receivers of an imaging device case 240.

The configuration of the anti-dust unit will be described with reference to mainly FIG. 3. An O-ring (rubber) 231 and the piezoelectric element 221 are arranged between the anti-dust filter 220 and the anti-dust filter receiving member 230. The shape of the piezoelectric element 221 is not limited to ring shape but may be reed shape.

The piezoelectric element 221 is affixed to the outer edge of the anti-dust filter 220 with, for example, an adhesive such that they become a single unit. Both sides of the anti-dust filter 220 are provided with an anti-reflection effect, for example, an AR coating. By sandwiching the O-ring 231 between the imaging device 202 and the anti-dust filter 220, sealed status of the anti-dust filter 220 and the imaging device 202 is maintained (see FIG. 4).

The piezoelectric element 221 has a flexible printed circuit board 232 crimped to the piezoelectric element 221. The flexible printed circuit board 232 has leads soldered thereto and is connected to the drive circuit 222.

The piezoelectric element 221 is driven by application of a voltage of a predetermined frequency from the drive circuit 222. This drive can produce a predetermined vibration of the anti-dust filter 220.

The anti-dust filter 220 is circular shaped (disk-shaped) or polygonal shaped, and is arranged in parallel and at the front of the optical LPF 241 with a predetermined space therebetween.

The anti-dust filter 220 is partially covered by a light-shielding sheet 233 and is held down by springs 235 held by spring supporters 234 through the light-shielding sheet 233, so as to maintain air sealing.

The anti-dust filter 220 has a circular or polygonal opening at substantially the center thereof. The opening is designed to be large enough to allow subject light passing through the imaging optical system to pass and allow the imaging device 202 arranged at the subsequent stage of the anti-dust filter 220 to perform photoelectric conversion.

In FIG. 4, the imaging device 202 is fixed on an imaging device fixing plate 242. A cover glass 244 is provided at the front of the imaging device 202. An optical LPF receiving member 243 is provided at the front of the cover glass 244. The optical LPF 241 is fixed to the optical LPF receiving member 243.

### 1-3. Configuration of the Drive Circuit

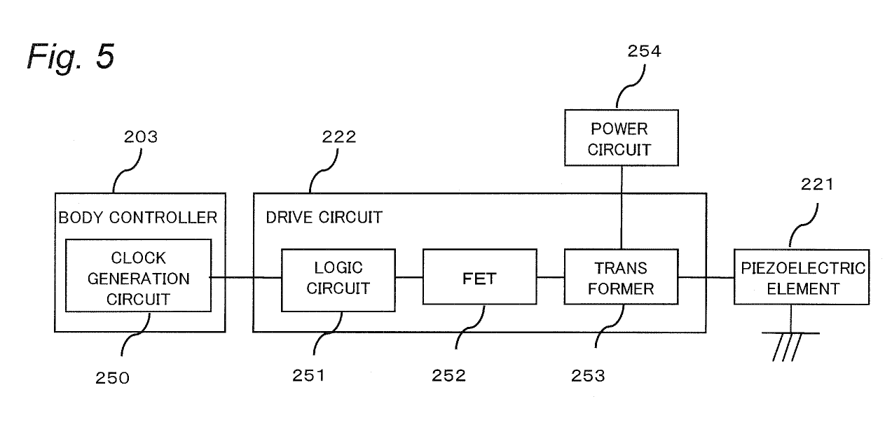

FIG. 5 shows a configuration of the drive circuit 222. The body controller 203 includes a clock generation circuit 250. A PWM signal generated by the clock generation circuit 250 in the body controller 203 passes through a logic circuit 251 in the drive circuit 222 and enters an FET 252. The FET 252 is connected to a primary side of a transformer 253. With a switching operation of the FET 252 and a voltage from a power circuit 254, a voltage of a predetermined frequency is generated from a secondary side of the transformer 253. With this configuration, a periodic voltage is applied to the piezoelectric element 221.

Note that the anti-dust filter 220 is an example of a vibrating unit. The piezoelectric element 221 is an example of a vibration applying unit. A configuration including the anti-dust filter receiving member 230, the O-ring 231, the spring supporters 234, the springs 235, and screws 236 is an example of a sealing unit.

### 2. Operation

### 2-1. Resonant Modes of the Anti-Dust Filter

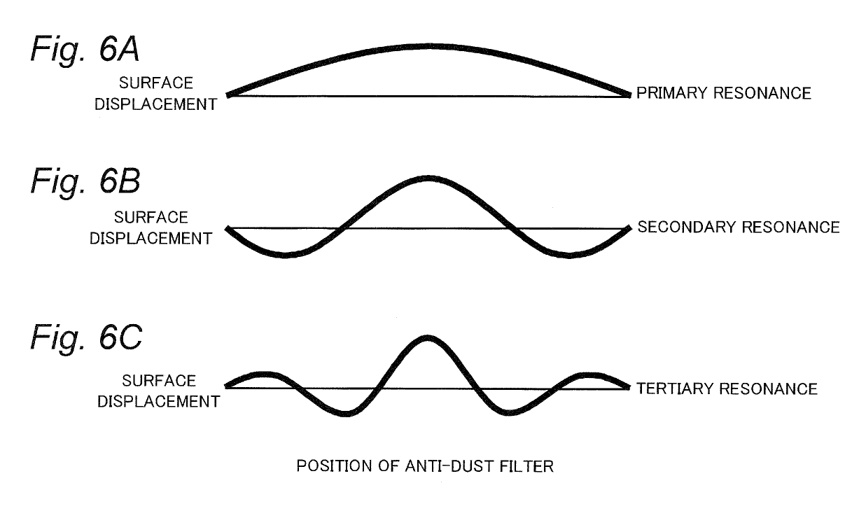

As described above, the anti-dust filter 220 vibrates by the drive of the piezoelectric element 221. Resonant modes generated by the vibration will be described with reference to FIGS. 6A to 6C.

FIGS. 6A to 6C show resonant modes to be generated when the shape of the anti-dust filter 220 is circular or polygonal nearly circular. When the anti-dust filter 220 has the other shapes such as a square, resonant modes to be generated are different from those shown in FIGS. 6A to 6C.

The resonant mode of vibration of the anti-dust filter 220 changes according to the frequency of a voltage applied to the piezoelectric element 221 from the drive circuit 222. As the frequency increases from lower value to higher value, first, a primary resonance as shown in FIG. 6A appears. As the frequency increases further a secondary resonance as shown in FIG. 6B appears, and as the frequency increases still further a tertiary resonance as shown in FIG. 6C appears. Thereafter, by further increasing the drive frequency, a higher-order resonance can be obtained.

vibration of the anti-dust filter 220 produced by the resonance can blow away and remove foreign particles, dust and the like, adhering to the anti-dust filter 220.

Normally, a surface is not displaced at a zero-amplitude position (node) of resonance. Hence, when foreign particles, dust and the like, adhere to a zero-amplitude position (section) of resonance, it is difficult to remove the foreign particles, dust and the like. By generating vibrations of a plurality of resonance orders on the anti-dust filter 220, the node position of the resonance can be changed, thereby reduction of foreign particles, dust and the like, can be effectively performed.

### 2-2. Thickness Relationship Between the Anti-Dust Filter and the Piezoelectric Element

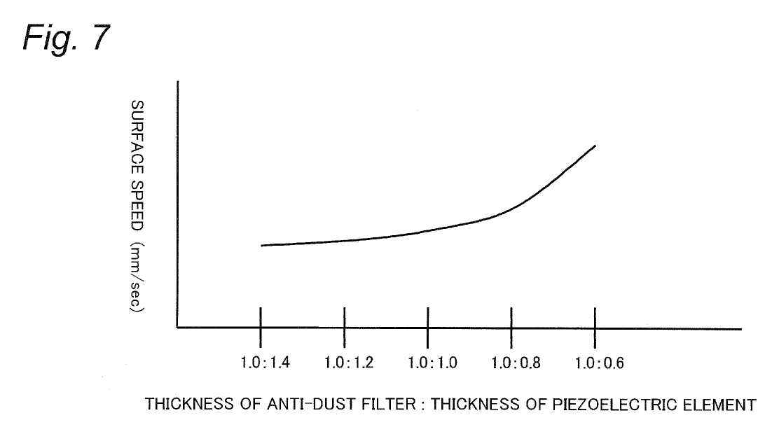

FIG. 7 shows relationship between the thickness ratio between the anti-dust filter 220 and the piezoelectric element 221 and the drive performance of the anti-dust filter 220.

FIG. 7 shows the drive performance of the anti-dust filter 220 with the constant driver energy applied to the piezoelectric element 221. The drive performance can be represented by a surface speed on the anti-dust filter 220. The drive performance improves as the surface speed increases. In the graph of FIG. 7, a vertical axis indicates the surface speed representing the drive performance and a horizontal axis indicates the ratio of the thickness of the piezoelectric element 221 to the thickness of the anti-dust filter 220.

In FIG. 7, in a range where the thickness of the piezoelectric element 221 is relatively greater than the thickness of the anti-dust filter 220, i.e., until the thicknesses of the anti-dust filter 220 and the piezoelectric element 221 become same (ratio of 1:1), the drive performance (surface speed) is substantially constant. As the thickness of the piezoelectric element 221 becomes relatively smaller than the thickness of the anti-dust filter 220, the drive performance (surface speed) improves. Particularly, in a range where the thickness ratio between the anti-dust filter 220 and the piezoelectric element 221 is lower than 1.0:0.8, the drive performance remarkably improves.

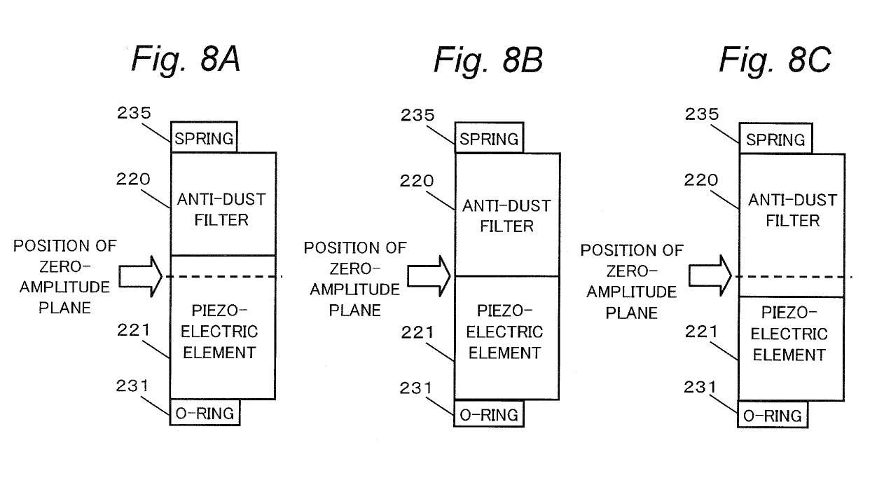

With reference to FIGS. 8A to 8C, it will be described that the drive performance can be improved by making the thickness of the piezoelectric element 221 smaller than the thickness of the anti-dust filter 220. Since the anti-dust filter 220 and the piezoelectric element 221 are held down to the O-ring 231 by the springs 235, a zero-amplitude reference plane in the resonance produced by vibration of the anti-dust filter 220 and the piezoelectric element 221 is located on any one of the anti-dust filter 220 and the piezoelectric element 221.

FIG. 8A shows an example case in which the thickness of the piezoelectric element 221 is greater than the thickness of the anti-dust filter 220. In this case, a zero-amplitude reference plane in the resonance to be produced is located on the piezoelectric element 221. This hinders vibration of the piezoelectric element 221 and accordingly the anti-dust filter 220 cannot be efficiently vibrated, degrading the drive performance of the anti-dust filter 220.

FIG. 8B shows an example case in which the thickness of the anti-dust filter 220 is same as the thickness of the piezoelectric element 221. In this case, a zero-amplitude reference plane in the resonance to be produced is located at a junction between the anti-dust filter 220 and the piezoelectric element 221. Hence, the drive performance of the piezoelectric element 221 improves more than the case shown in FIG. 8A but the piezoelectric element 221 and the anti-dust filter 220 cannot be vibrated as efficiently as the case shown in FIG. 8C which will be described later. Furthermore, in the case of FIG. 8B, since the zero-amplitude reference plane is located at the junction between the anti-dust filter 220 and the piezoelectric element 221, there is a problem that damage occurs on a bonding surface between the anti-dust filter 220 and the piezoelectric element 221.

FIG. 8C shows an example case in which the thickness of the anti-dust filter 220 is greater than the thickness of the piezoelectric element 221. In this case, a zero-amplitude reference plane of the resonance to be produced is located on the anti-dust filter 220. Hence, the piezoelectric element 221 is not inhibited from vibrating and thus the anti-dust filter 220 can be efficiently vibrated, enabling to improve the drive performance of the anti-dust filter 220.

From the above-described findings, in the present embodiment, the thickness of the anti-dust filter 220 is made greater than the thickness of the piezoelectric element 221. With this arrangement, a zero-amplitude reference plane in the resonance to be produced is located on the anti-dust filter 220 and thus the anti-dust filter 220 can be efficiently vibrated, enabling to improve the drive performance of the anti-dust filter 220.

Note that it is preferred that the shape of the anti-dust filter 220 be circular (disk-like) as shown in the present embodiment. This is because when the anti-dust filter 220 has a quadrilateral shape, the vibration mode varies from location to location and thus it is difficult to make the anti-dust filter 220 efficiently vibrate.

Although in the present embodiment the springs 234 and the O-ring (rubber) 231 are used as means of sandwiching the anti-dust filter 220 and the piezoelectric element 221, the sandwiching means are not limited thereto. Needless to say, any member can be used as long as the members can support the anti-dust filter 220 and the piezoelectric element 221 by sandwiching them from the outsides thereof.

### INDUSTRIAL APPLICABILITY

An imaging apparatus according to the present embodiment can efficiently vibrate an anti-dust filter arranged at the front of an imaging device and thus it can improve an anti-dust function. Thus the imaging apparatus can be applied and useful to imaging apparatuses such as digital still cameras and digital video cameras.

Although the present embodiment has been described above in relation to a particular embodiment thereof, many other variations, modifications, and other uses will be apparent to those skilled in the art. Therefore, the present invention is not limited by the specific disclosure herein, but only by the appended claims. Note that the present application is related to Japanese Patent Application No. 2008-233200, filed Sep. 11, 2008, the content of which is incorporated herein by reference.

What is claimed is:

1. An imaging apparatus comprising:
an imaging device operable to convert light to an electrical signal;
a vibrating unit including an optical member arranged on a light-receiving surface side of the imaging device;
a vibration applying unit arranged to contact the vibrating unit and vibrate upon application of a voltage, the vibration applying unit vibrating integrally with the vibrating unit to vibrate the vibrating unit; and
a member operable to sandwich the vibrating unit and the vibration applying unit, wherein
a zero-amplitude reference plane of a resonance produced by the integral vibration of the vibrating unit and the vibration applying unit is located on the vibrating unit.

2. The imaging apparatus according to claim 1, wherein a thickness of the vibrating unit is greater than a thickness of the vibration applying unit.

3. The imaging apparatus according to claim 1, further comprising a sealing member provided around outer edges of the imaging device and the vibrating unit, for sealing a space formed between the imaging device and the vibrating unit.

4. The imaging apparatus according to claim 1, wherein the vibrating unit is disk-shaped.

5. The imaging apparatus according to claim 1, wherein the vibrating unit is an anti-dust filter.

6. The imaging apparatus according to claim 1, wherein the vibration applying unit includes a piezoelectric element.

7. The imaging apparatus according to claim 1, wherein the vibration applying unit is bonded to a surface of the vibrating unit on a side of the vibrating unit facing the imaging device.

8. The imaging apparatus according to claim 2, further comprising a sealing member provided around outer edges of the imaging device and the vibrating unit, for sealing a space formed between the imaging device and the vibrating unit.

9. The imaging apparatus according to claim 2, wherein the vibrating unit is disk-shaped.

10. The imaging apparatus according to claim 2, wherein the vibrating unit is an anti-dust filter.

11. The imaging apparatus according to claim 2, wherein the vibration applying unit includes a piezoelectric element.

12. The imaging apparatus according to claim 2, wherein the vibration applying unit is bonded to a surface of the vibrating unit on a side of the vibrating unit facing the imaging device.

13. A dust reduction apparatus for preventing adherence of dust onto a predetermined member, the dust reduction apparatus comprising:
a vibrating unit that can be arranged at a front of the predetermined member;
a vibration applying unit arranged to contact the vibrating unit and vibrate upon application of a voltage, the vibration applying unit vibrating integrally with the vibrating unit to vibrate the vibrating unit; and
a member operable to sandwich the vibrating unit and the vibration applying unit, wherein
a zero-amplitude reference plane of a resonance produced by the integral vibration of the vibrating unit and the vibration applying unit is located on the vibrating unit.

14. The dust reduction apparatus according to claim 13, wherein a thickness of the vibrating unit is greater than a thickness of the vibration applying unit.

15. The dust reduction apparatus according to claim 13, wherein the vibrating unit is disk-shaped.

16. The dust reduction apparatus according to claim 13, wherein the vibration applying unit includes a piezoelectric element.

17. The dust reduction apparatus according to claim 13, wherein the predetermined member is an imaging device operable to convert light to an electrical signal.

18. The dust reduction apparatus according to claim 14, further comprising a sealing member provided around outer edges of the predetermined member and the vibrating unit, for sealing a space formed between the predetermined member and the vibrating unit.
